(19) United States
(12) Patent Application Publication
(10) Pub. No.: US 2005/0170316 A1
(43) Pub. Date: Aug. 4, 2005

(54) Toothbrush for detecting the presence of plaque

(76) Inventors: Bruce M. Russell, Howell, NJ (US); Robert A. Moskovich, East Brunswick, NJ (US); Michael Prencipe, West Windsor, NJ (US); Diego Hoic, Jersey City, NJ (US)

Correspondence Address: COLGATE-PALMOLIVE COMPANY, 909 RIVER ROAD, PISCATAWAY, NJ, 08855, US

(21) Appl. No.: 10/767,573

(22) Filed: Jan. 29, 2004

(51) Int. Cl. A61C 17/00

(52) U.S. Cl. 433/216; 15/105; 433/29

(57) ABSTRACT

A dye is incorporated in a carrier. The dye has the characteristics of attaching itself to residual plaque on the tooth surface. The dye also has the characteristic of being activated by the presence of ultraviolet radiation to visually create a fluorescent effect that would indicate the presence of plaque remaining on the teeth. The carrier can be toothpaste or any other form of tooth applicator, such as a rinse or gum. The UV light source could be from a separate device or could be mounted in the toothbrush itself.

### BACKGROUND OF THE INVENTION

Various techniques have been used attempting to detect the presence of plaque on one's teeth. Such techniques include, for example, the application of various compositions to the teeth which are intended to visually indicate the presence of plaque. It would be highly advantageous for a person brushing one's teeth to obtain feedback immediately upon brushing regarding the brushing effectiveness.

### SUMMARY OF THE INVENTION

An object of this invention is to provide techniques for giving an immediate feedback where residual plaque remains on a user's teeth.

A further object of this invention is to provide such techniques which utilize a toothbrush in connection with the detection of plaque.

In accordance with this invention a dye is incorporated in a carrier. The dye has the characteristic of being able to attach itself to residual plaque on the tooth surface and also has the characteristic of becoming flourescent in the presence of ultraviolet radiation. In the broad practice of this invention an ultraviolet light source is used for directing ultraviolet light against the teeth so that the flourescent effect would be created and easily visible to the user to indicate the presence of residual plaque.

In a preferred practice of this invention the ultraviolet light source is incorporated in a toothbrush. The carrier for the dye could be the toothpaste on the toothbrush cleaning head. Alternatively, the carrier could be some form of liquid such as an oral rinse or mouthwash or could be a gum or lozenge or polymer strip or any other common devices used for delivering oral health benefits.

### THE DRAWINGS

FIG. 1 is a side elevational view of a manual toothbrush in accordance with this invention;

FIG. 2 is a front elevational view of the toothbrush shown in FIG. 1;

FIG. 2A is a view similar to FIG. 2 showing a toothbrush head with surface mounted LEDs;

FIG. 3 is a side elevational view of a powered toothbrush in accordance with this invention; and

FIG. 4 is a front elevational view of the toothbrush shown in FIG. 3.

### DETAILED DESCRIPTION

The present invention broadly involves applying a special dye to a user's teeth. The dye has the characteristic of attaching itself to residual plaque on the tooth surface. The dye has the further characteristic that it can be actuated by the presence of ultraviolet radiation and would then have a fluorescent effect that would be easily visible to the user. In a preferred practice of this invention the ultraviolet radiation is emitted from a toothbrush. As a result, when the user is brushing the user's teeth and after rinsing there is an immediate feedback upon brushing regarding the brushing effectiveness. If the dye becomes visible the user knows that not all of the plaque has been removed. In a broad practice of this invention, however, the ultraviolet or UV light source could be any device that provides the light emissions for the teeth.

Various types of carriers may be used for applying the dye to the teeth. A convenient form of carrier could be by incorporating the dye in the toothpaste itself. Other forms of carriers could be conventional products that would be applied to the mouth. Such products include, but are not limited to, an oral rinse or mouthwash, a gum or lozenge, a polymer strip carrier which may or may not dissolve, or any other common means of delivering oral health benefits.

Any suitable dye could be used in the practice of this invention as long as the dye has the two characteristics noted above with respect to attaching itself to residual plaque and with respect to having a visible fluorescent effect in the presence of ultraviolet radiation. The dye should be absorbed in the plaque but not to the teeth. Before inspecting the teeth for plaque, the user would spit or rinse and spit the carrier and dye from the mouth, leaving only the dye attached to any plaque. One form of suitable dye is TINOPAL, marketed by Ciba Geigy. Preferably only a small amount of dye is necessary, such as 0.075 to 0.30% by volume of the total combination of the carrier and dye.

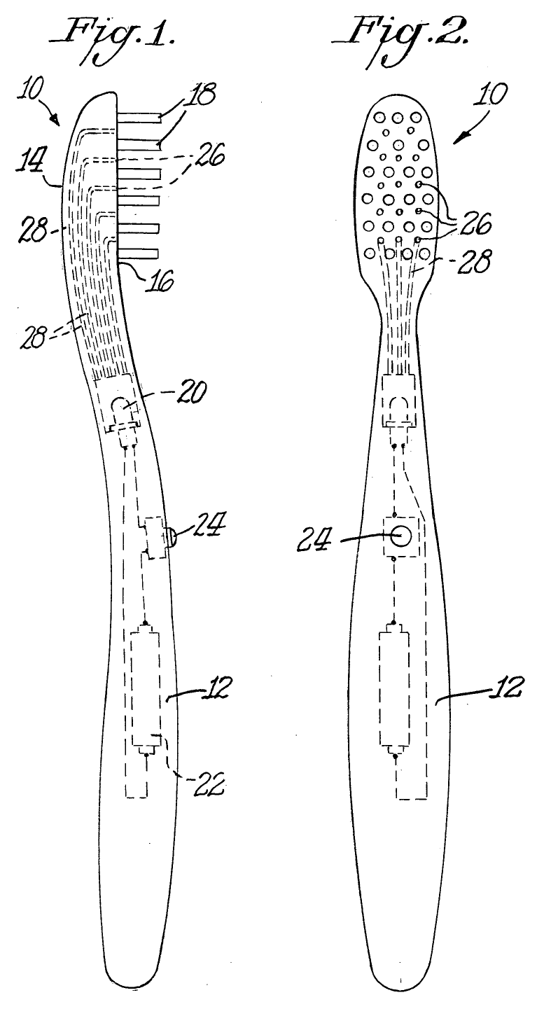

FIGS. 1-2 show a manual toothbrush 10 that may be used in accordance with this invention. As shown therein the toothbrush 10 includes a hollow handle 12 and a cleaning head 14. Cleaning head 14 has an outer surface 16 from which a plurality of cleaning elements 18 extend outwardly. Cleaning elements 18 may be of any suitable form such as bristles or elastomer members of any size or shape. The cleaning elements may also be a combination of different types of cleaning elements. The cleaning elements 18 are arranged on the outer surface 16 of the cleaning head to form a cleaning field. Thus the light(s) is located within the cleaning field.

Mounted within the hollow handle 12 is a source 20 of ultraviolet light. Any suitable source may be used such as miniature UV bulbs as manufactured by Welch Allyn. Although miniature UV bulbs may be used this is a less preferred practice of the invention in that generally such bulbs are of relatively large size with high power consumption and tend to emit undesired UVB radiation. A more preferred practice of the invention would be the use of LEDs as the source 20 of ultraviolet light. A particular advantage of LEDs is that they can be surface mounted. In addition LEDs would have small or low power consumption and provide tight emissions in a tight spectrum band with minimum power requirements and have relatively low intensity. The LEDs could preferably have a safe UVA wavelength of 350-410 nm and more preferably a wavelength of 378-383 nm. Suitable LEDs can be obtained from Roithner Lasertechnik of Vienna, Austria. A suitable LED would be a 3.0×2.2×1.5 mn 3TOP LED. Whatever form of source is used, care should be taken to control the intensity of the UV radiation in order to avoid possible negative health effects.

Although the ultraviolet light can constantly be emitted, it is preferable that the light source be selectively actuated. Any suitable structure could be used for accomplishing that task. FIGS. 1-2, for example, show the hollow handle 12 to include a battery 22 electrically connected to the UV light source 20. A switch 24 located externally on the handle 12 selectively actuates the light source 20.

When the light source 20 is actuated the light is transmitted from the handle to the carrier field and to at least one emitter 26 in the carrier field. The light could be transmitted in any suitable manner by transmitting structure 28 such as a light pipe, fiber optic, or other suitable devices. Preferably, the light(s) or emitters 26 are surface mounted and are located in the carrier field. FIG. 2A, for example, shows two surface mounted emitters 26 in the form of LEDs.

In one use of toothbrush 10 toothpaste would be applied to the outer ends of the cleaning elements 18, such as bristles. The toothpaste would incorporate the dye. In the normal use of the toothbrush the toothpaste would be applied to the teeth. The dye in the toothpaste would become attached to or be absorbed by residual plaque on the tooth surface. Upon rinsing the dye would be located only on the plaque. Either during or preferably immediately after the brushing and rinsing the user would actuate the ultraviolet light source 20 through switch 24 to radiate the ultraviolet light from the emitters toward the teeth. If any residual plaque is present the dye would have remained attached to the plaque and in the presence of the ultraviolet radiation there would be readily visual fluorescent effect. This would alert the user that it is necessary to continue the brushing or to be at least aware that all of the plaque has not been removed. It would also provide immediate feedback to the user as to the user's brushing habits and areas where improvement in the brushing habits are necessary.

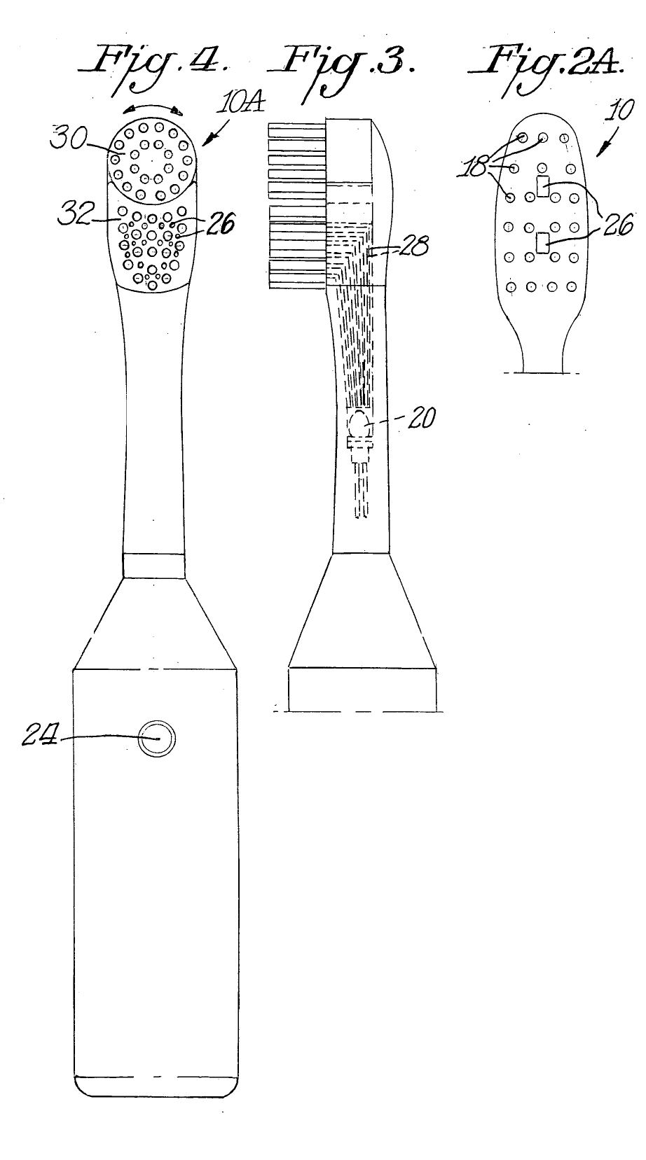

Although FIGS. 1-2 illustrate the toothbrush to be a manual toothbrush it is also possible to practice the invention with a powered toothbrush 10A as shown in FIGS. 3-4. In that embodiment the powered toothbrush includes a moveable section 30 in the cleaning field. Movable section 30 could be of any size or shape and could be moved in any known manner such as continuous rotation in one direction, oscillating rotation or linear back and forth and/or side to side movement. One example of movement is an oscillating back and forth rotational movement such as disclosed in U.S. Pat. No. 5,625,916, all of the details of which are incorporated herein by reference thereto. In the illustrated embodiment toothbrush 10A includes in its cleaning field a fixed portion 32 which does not move but which also contains cleaning elements. For the sake of simplicity the emitters are located only in the fixed portion 32 rather than having to account for the movability of the optic fibers or light pipe if the emitters were also located in the movable section 30. It is, however, in the scope of this invention that the emitters could be in either the movable section 30 and/or the fixed section 32.

The invention could be practiced where the same switch 24 actuates both the light source 20 and the drive mechanism for the movable section 30. Alternatively, the movable section and the light source could be actuated by separate switches.

If desired, the method of this invention could be practiced where the applicator is not toothpaste. For example, an oral rinse or mouthwash or other liquid applicator could be applied to the teeth and then the user discharges the applicator from the mouth, such as by a gargling with the liquid applicator or with water and then spitting the excess applicator and dye from the mouth leaving only the dye that is attached to the residual plaque in the mouth on the tooth surface. Other forms of applicators could be a gum or lozenge or polymer strip. Preferably after the application the user would rinse with water to remove excess carrier and dye. The UV light source whether from a toothbrush or a separate light source could then be actuated to radiate the UV light toward the teeth. By using any of the combinations of applicator and UV light source the user can easily see how effective the cleaning operation, such as tooth brushing, has been.

1. A toothbrush for detecting the presence of plaque on the user's teeth, comprising a handle, a cleaning head attached to said handle, said cleaning head having an outer surface, cleaning elements on said cleaning head extending outwardly from said outer surface, said cleaning elements being located in a cleaning field, said toothbrush having an ultraviolet light, and said ultraviolet light having an emitter in said cleaning field to radiate ultraviolet light toward the user's teeth for activating a dye on any plaque on the user's teeth to create a visual fluorescent effect that would indicate the presence of said plaque.

2. The toothbrush of claim 1 wherein said handle is hollow, said ultraviolet light having a light source in said handle, and light transmission structure transmitting the ultraviolet light to said emitter.

3. The toothbrush of claim 2 wherein said light source is a miniature UV bulb.

4. The toothbrush of claim 2 wherein said light source is at least one UV emitting LED.

5. The toothbrush of claim 4 wherein said at least one LED is surface mounted to said toothbrush.

6. The toothbrush of claim 5 wherein said at least one LED has a wavelength of 350-410 nm.

7. The toothbrush of claim 2 wherein said toothbrush is a manual toothbrush.

8. The toothbrush of claim 7 wherein said light source is selectively actuated by a switch on said handle.

9. The toothbrush of claim 2 wherein said toothbrush is a powered toothbrush having a movable cleaning element carrying section in said cleaning head.

10. The toothbrush of claim 9 wherein said light source is selectively actuated by a switch on said handle.

11. The toothbrush of claim 10 wherein said switch also actuates said movable section.

12. The toothbrush of claim 9 wherein said cleaning head also includes a non-movable fixed section having cleaning elements, and said emitter is located in said fixed section.

13. The toothbrush of claim 1 wherein said emitter emits UV light from plural locations in said cleaning field.

14. The toothbrush of claim 1 wherein at least some of said cleaning elements are bristles

15. A method for detecting the presence of plaque on a user's teeth comprising incorporating in a carrier a dye which has the characteristic of attaching to plaque and which has the characteristic of being fluorescent in the presence of UV light, applying the carrier to the user's teeth, attaching the dye to any plaque on the user's teeth, radiating UV light from a UV light source toward the user's teeth, and creating a visual fluorescent effect where plaque is present on the user's teeth.

16. The method of claim 15 including removing excess dye and carrier from the user's teeth before radiating the UV light toward the user's teeth.

17. The method of claim 16 wherein the excess dye and carrier are removed by a rinse and spitting action.

18. The method of claim 15 wherein the carrier is selected from the group consisting of toothpaste, oral rinse, oral mouthwash, gum, lozenge and a polymer strip.

19. The method of claim 15 wherein the carrier is in liquid form and is gargled for applying the carrier to the user's teeth.

20. The method of claim 15 wherein the UV light source is in a toothbrush.

21. The method of claim 20 wherein the carrier is toothpaste applied to the toothbrush.

22. The method of claim 20 wherein the UV light source is selectively activated by a switch.

23. The method of claim 20 wherein the toothbrush is a manual toothbrush.

24. The method of claim 20 wherein the toothbrush is a powered toothbrush.
